(19) United States
(12) Patent Application Publication
(10) Pub. No.: US 2009/0188713 A1
(43) Pub. Date: Jul. 30, 2009

(54) HIDING CABLES RUNNING ALONG A SURFACE

(75) Inventor: Theodorus Franciscus Emilius Maria Overes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,466

(22) PCT Filed: Jun. 28, 2007
(86) PCT No.: PCT/IB07/52507

§ 371 Date: Dec. 18, 2008

(30) Foreign Application Priority Data
Jun. 29, 2006 (EP) 06116301.0

(51) Int. Cl. H02G 3/08

(52) U.S. Cl. 174/504

(57) ABSTRACT

A structure (1) hides a cable (2) running along a surface (3). The structure (1) comprises a wall (10, 11; 12, 13, 14) arranged between a viewer (4) and the cable (2) for hiding the cable (2) for the viewer (4). The structure has a wall surface directed towards the viewer (4). At least part of the wall surface directed towards the viewer (4) has reflective properties. The wall (10, 11; 12, 13, 14) has a shape for reflecting the surface (3) or another surface (30) having similar appearance as the surface (3) to the viewer (4), thereby giving the structure which hides the cable a similar appearance as the surface in front of which the cable is arranged.

### FIELD OF THE INVENTION

The invention relates to a structure for hiding a cable running along a surface from a viewer, and to a system comprising such a structure.

### BACKGROUND OF THE INVENTION

US2003/0106702A1 discloses a surface-mounted wiring raceway or conduit with a snap-on cover. The exposed surfaces are similar in appearance to those of ordinary architectural interior or exterior moldings presently used in homes and commercial structures. The moldings are designed to provide at least one channel or passageway for wiring, cables, and other power, communication, networking, and control transmissions, or to cover existing wiring conduits and raceways. The design of the surfaces is selected to have a good resemblance with classical wood millwork such that the moldings fit in the interior and are non-obtrusive.

### SUMMARY OF THE INVENTION

It is an object of the invention to improve hiding of a cable running along a surface.

A first aspect of the invention provides a structure for hiding a cable as claimed in claim 1. A second aspect of the invention provides a system as claimed in claim 12. Advantageous embodiments are defined in the dependent claims.

A structure for hiding a cable running along a surface in accordance with the first aspect of the invention comprises a wall which, in use, is arranged between the viewer and the cable and thus hides the cable for the viewer. The wall is shaped and at least part of a side of the wall which is directed to the viewer has reflective properties for reflecting the surface or another surface which has a similar appearance as the first mentioned surface to the viewer. For example, the surface may be a wall of a room in front of which the cable is arranged, and the another surface may be another wall of the room.

Thus, in use, the structure is arranged in front of the surface to cover the cable from the viewer, while the reflective walls reflect this surface or a similar surface towards the viewer. Consequently, the viewer sees the surface instead of the cable and even instead of the structure. There is no need to select a surface of the structure which optimally fits the actual interior. Usually, the surface is a wall of a room. But the surface may be any surface along which a cable runs which has to hidden, such as the surface of a cabinet.

In an embodiment as claimed in claim 2, the wall forms an elongated cavity which provides space for the cable when the cable is arranged between the wall and the surface.

In an embodiment as claimed in claim 3, the wall is V-shaped and at least part of the outer side of the V shape has the reflective properties. The cable may fit into the interior of the cavity formed by the V. This V-shape is a simple shape which provides side walls which reflect the surface to the viewer.

In an embodiment as claimed in claim 4, the V-shaped structure is obtained by arranging two reflective elements in the V-shape. These two elements may be glued together at the top of the V-shape, or may be mechanically interconnected by a suitable interconnection structure.

In an embodiment as claimed in claim 5, the mechanical interconnection structure enables to change the angle of the two elements with respect to each other. In case of a repeating texture on the surface, a good result will be reached with a reflective surface which is positioned perpendicular to the surface. This has the further advantage that the viewing angle providing the intended effect is maximal. On the other hand the volume of the cavity of the V-shaped element will be minimal and might not be sufficient to contain the cable(s). The adjustable top angle of the V-shape allows the viewer to select an optimum angel for his or her situation. In an embodiment, the angle is selected as small as possible to get the best duplication of the surface structure and the maximum viewing angle, but is sufficient large to allow the cable to fit in the cavity formed. A practical range for the top angle which fits this demands may be 40 to 60 degrees.

In an embodiment as claimed in claim 6, the top angle of the V shape is selected or is adjustable between 40 and 60 degrees. The adjustable top angle allows the viewer to select the reflection of the surface to its best liking. This is especially relevant if the surface has a repeating texture which cannot be reflected to the viewer while keeping the same repeating distance.

In an embodiment as claimed in claim 7, the wall has a U shape comprising a top segment between two legs. An angle between an inner side of each one of the legs and an inner side of the top segment is equal to or larger than 90 degrees. Preferably, in use, the top segment will be arranged in parallel to the surface. If the angle is larger than 90 degrees, the legs protrude to outside the area covered by the top segment. This embodiment provides on the one hand at least partly reflective legs which are arranged perpendicular or almost perpendicular to the surface while on the other hand sufficient volume is present to contain the cable(s). A drawback is that the top segment becomes visible to the viewer.

In an embodiment as claimed in claim 9 the wall of the structure facing the viewer has a texture creating a non flat surface for scattering light. Especially if the surface has a repeating texture, the scattering of the light blurs this repeating texture making it less obtrusive that the reflected texture has a different repeating distance than the texture on the surface. On the other hand, the reflected light still has the average color and intensity of the surface and thus still hides the cable and the hiding structure reasonably well. A textured reflective surface has further the advantage that it allows a lower specification on its flatness which results in a cheaper structure. Further, the effect of disturbing objects or light spots on the surface is reduced.

In an embodiment as claimed in claim 10, the reflective surface of the walls is flat to minimize distortions of the reflected part of the surface. A further advantage of flat reflective surfaces is that it maximizes the enclosed volume at a particular maximum viewing angle.

In an embodiment as claimed in claim 11, a mirror is used for the reflective surface. The high reflectivity of a mirror improves the resemblance between the reflected part of the surface and the surface.

The system in accordance with the second aspect comprises the structure for hiding the cable, and a display apparatus which is arranged in front of the surface. The cable is connected to the display apparatus. And the structure for hiding the cable is arranged in front of the surface such that the cable is shielded from the viewer and reflects part of the surface to the viewer.

These and other aspects of the invention are apparent from and will be elucidated with reference to the embodiments described hereinafter.

### BRIEF DESCRIPTION OF THE DRAWINGS

In the drawings:

FIG. 1 shows a display apparatus hanging on a wall and a structure for hiding a cable running along the wall,

FIG. 2 shows a cross section of an embodiment of the structure, and

FIG. 3 shows a cross section of another embodiment of the structure.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

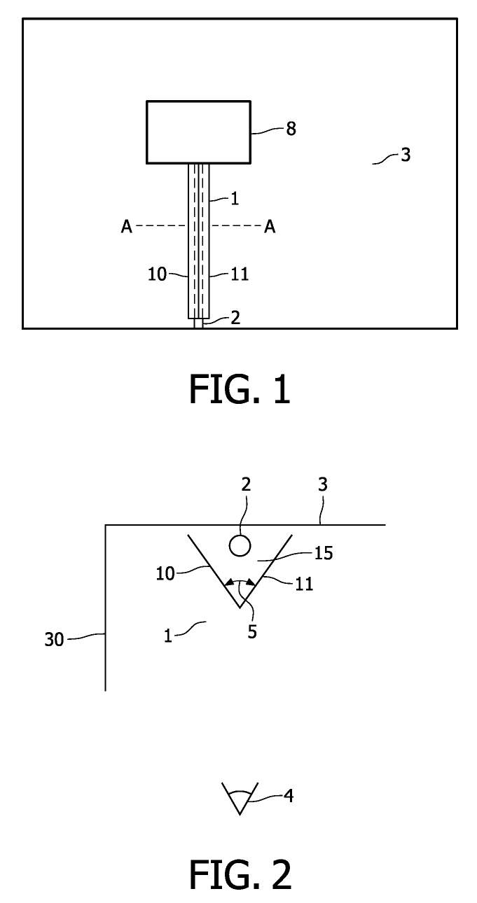

FIG. 1 shows a display apparatus hanging on a wall and a structure for hiding a cable running along the wall. The display apparatus 8 is mounted in front of the wall 3 of a room. The display apparatus 8 may actually be mounted on the wall 3, but alternatively may hang from the ceiling or stand on the floor. If the display apparatus 8 is hanging on the wall the structure 1 which hides the cable 2 connected to the display 8 does not support the display apparatus 8. If the display apparatus 8 is standing on the floor, the structure 1 may also be the supporting structure. Although the structure 1 extends from the bottom of the display apparatus 8 to the floor, alternatively, the structure 1 may extend in another direction, such as for example from the top of the display apparatus to the ceiling, or sideward. Especially if the display is hanging on the ceiling, the structure 1 may also have the mounting function.

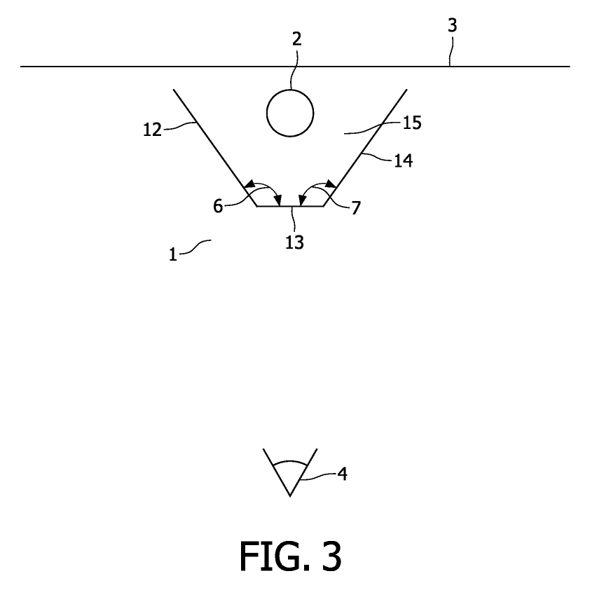

The structure 1 creates a cavity 15 (see FIG. 2) which may hold the cable 2. In use, the structure 1 is positioned such that the cable 2 is in the cavity 15 and is arranged between the wall 3 and the structure 1 such that the cable is shielded by the structure 1 from a viewer 4 (see FIGS. 2 and 3) which is in the room. The viewing angle of the viewer is defined as the angle between a line perpendicular to the display surface of the display screen of the display apparatus 8 and an imaginary line connecting the viewer position and the center of the display screen. The maximum viewing angle for which the intended hiding effect is obtained depends on the construction of the hiding structure. The cavity 15 may be dimensioned to hold a plurality of cables. The cables 2 may, for example, provide power and/or signals to the display apparatus 8. The cables 2 may also interconnect peripheral apparatuses (not shown) with the display apparatus 8 and provide signals from the display apparatus 8 to the peripheral apparatus.

The wall(s) 10, 11 of the structure 1 should have reflective properties. To prevent confusion between the wall 3 of the room and the wall(s) 10, 11 of the structure 1, the wall 3 of the room is also referred to as the surface 3. The structure 1 may comprise a one piece wall. Alternatively, the structure 1 may comprise, or may be formed by, a plurality of walls 10, 11. In the embodiment shown in FIG. 1, the structure 1 comprises two walls 10 and 11 which are arranged in a V. The wall or walls 10, 11 of the structure 1 need not form a V but should be arranged such that a portion of the surface 3 is reflected towards the viewer 4. By reflecting a portion of the surface 3, the visibility of the wall(s) 10, 11 is minimized because the viewer 4 has the impression that the surface 3 is also present in front of the cable 2. Alternatively, as shown in FIG. 2, the structure may reflect another surface 30 which has a similar appearance as the surface 3. Usually, this another surface 30 is another wall of the room in which the cable has to be hidden.

FIG. 2 shows a cross section of an embodiment of the structure. FIG. 2 shows a cross section of the structure 1 of FIG. 1 along the plane perpendicular to the surface 3 as indicated by the line AA in FIG. 1. The V shaped structure 1 creates a cavity 15 which has dimensions to hold the single cable 2 or a plurality of cables. The structure 1 may be formed by a single wall with two surfaces 10 or 11. Alternatively the structure 1 may comprise two walls 10 and 11. The two walls 10, 11 may be rigidly interconnected, by example by gluing them together at the top of the V. The two walls 10, 11 may be rigidly interconnected in any other way and together be fastened to the surface 3, or each of the walls 10, 11 may be rigidly fastened to the surface 3. Alternatively, the two walls 10, 11 may be movably interconnected with each other or which the surface 3. Such an adjustable construction allows the user to adjust the angle of the walls 10, 11 with respect to the surface 3 to his or her liking. This is especially relevant if the surface 3 or 30 which has to be reflected to the viewer has a texture. The adjustable construction offers the possibility to maximize the maximum viewing angle for a particular number of cables to be covered.

FIG. 3 shows a cross section of another embodiment of the structure. This structure 1 is U shaped or said differently has a V shape with a flattened top portion. The top of the U is formed by the wall or wall portion indicated by 13, the left leg of the U is formed by the wall or wall part 12, and the right leg is formed by the wall or wall part 14. Although the wall parts 12, 13, 14 are shown to be flat, these walls may be curved. The wall or wall portion 13 decreases the invisibility of the structure 1 but may add an aesthetic element. To prevent to decrease the invisibility of the structure 1 too much, the surface area of the wall or wall portion 13 should be limited. The effect of the U-shaped structure is that the viewer gets the impression that surface 13 is floating in front of surface 3, thereby hiding the cables arranged between the surface 13 and the structure 1.

In the same manner as discussed with respect to the structure 1 shown in FIG. 2, the structure 1 may be formed as a single wall comprising the wall portions 12, 13, 14. Alternatively, the structure 1 may comprise separate walls which are rigidly or movably interconnected.

It should be noted that the above-mentioned embodiments illustrate rather than limit the invention, and that those skilled in the art will be able to design many alternative embodiments without departing from the scope of the appended claims.

For example, any shape of the structure 1 which reflects a portion of the surface 3 towards the viewer 4 decreases the visibility of the structure 1. The wall(s) 10, 11; 12, 13, 14 need not be flat; a curved plane can also be used. The reflection need not be 100%; a lower reflection percentage will already have a hiding effect. The reflective wall(s) 10, 11; 12, 13, 14 may be textured to obtain height differences which scatter the light. Especially if the surface 3 has a texture which repeats at a particular distance, a 100% reflection shows this repeating texture in front of the structure 1, but with a repetition distance which might differ from the particular distance. The somewhat annoying effect of a repetition distance which differs from the particular distance can be minimized by selecting a lower than 100% reflection, and/or a suitable surface texture of the reflective walls.

In an embodiment, the structure 1 which hides the cable 2 running along a surface 3 from the viewer 4 has a wall 10, 11; 12, 13, 14 which forms an elongated cavity 12 providing space for the cable 2 when arranged between the wall 10, 11; 12, 13, 14 and the surface 3. At least part of an outer side of the wall 10, 11; 12, 13, 14 has reflective properties and is shaped for reflecting the surface 3 to the viewer 4. Thus, the reflective part of the structure which hides the cable gets a similar appearance as the surface in front of which the cable is arranged and both the cable and the hiding structure are completely or almost invisible for the viewer.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A structure (1) for hiding a cable (2) running along a surface (3), the structure (1) comprises a wall (10, 11; 12, 13, 14) being in use arranged between a viewer (4) and the cable (2) for hiding the cable (2) for the viewer (4), and having a wall surface directed towards the viewer (4), wherein at least part of the wall surface directed towards the viewer (4) has reflective properties, the wall (10, 11; 12, 13, 14) being shaped for reflecting the surface (3) or another surface (30) having similar appearance as the surface (3) to the viewer (4).

2. A structure (1) for hiding a cable (2) as claimed in claim 1, wherein the wall (10, 11; 12, 13, 14) forms an elongated cavity (15) providing space for the cable (2) when arranged between the wall (10, 11; 12,13, 14) and the surface (3).

3. A structure (1) for hiding a cable (2) as claimed in claim 1, wherein the wall (10, 11) is V shaped.

4. A structure (1) for hiding a cable (2) as claimed in claim 3, comprising two reflective elements (10, 11) arranged in the V shape.

5. A structure (1) for hiding a cable as claimed in claim 3, wherein a top angle (5) of the V shape is adjustable.

6. A structure (1) for hiding a cable as claimed in claim 3, wherein a top angle (5) of the V shape is selected or is adjustable between 40 and 60 degrees.

7. A structure (1) for hiding a cable (2) as claimed in claim 1, wherein:
the wall (12, 13, 14) has a U shape comprising a top segment (13) between two legs (12, 14), and
at least part of the outer side of the legs (12, 14) have reflective properties.

8. A structure (1) for hiding a cable (2) as claimed in claim 7, wherein an angle (6, 7) between an inner side of each one of the legs (12, 14) and an inner side of the top segment (13) is equals to or larger than 90 degrees.

9. A structure (1) for hiding a cable (2) as claimed in claim 1, wherein the wall (10, 11; 12, 13, 14) facing the viewer has a texture creating a non-flat surface for scattering light.

10. A structure (1) for hiding a cable (2) as claimed in claim 1, wherein the wall (10, 11; 12, 13, 14) facing the viewer has a flat reflective surface.

11. A structure (1) for hiding a cable (2) as claimed in claim 1, wherein the walls (10, 11; 12, 13, 14) or the reflective surface are provided by a mirror.

12. A system comprising:
the structure (1) for hiding the cable (2) as claimed in claim 1, and
a display apparatus (8) arranged in front of the surface (3), wherein the cable (2) is connected to the display apparatus (8), and
wherein the structure (1) for hiding the cable (2) is arranged in front of the surface (3) thereby covering the cable (2) and reflecting the surface (3) or another surface (30) having similar appearance as the surface (3) to the viewer (4).

13. A system as claimed in claim 12, wherein the cable (2) is a power cable for supplying power to the display apparatus (8).
